(19) United States
(12) Patent Application Publication
(10) Pub. No.: US 2009/0123291 A1
(43) Pub. Date: May 14, 2009

(54) Coatings for Use in the Field of Power Generation

(76) Inventors: Rudolf Gensler, Erlangen (DE); Rainer Nies, Uttenreuth (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/989,810

(22) PCT Filed: Aug. 7, 2006
(86) PCT No.: PCT/EP2006/065106

§ 371 Date: Jan. 31, 2008

(30) Foreign Application Priority Data
Aug. 11, 2005 (DE) 10 2005 038 119.7

(51) Int. Cl. F01D 5/28; B05D 3/06

(52) U.S. Cl. 416/241 R; 415/200; 427/180; 427/553; 524/588

(57) ABSTRACT

There is described a method for coating the surfaces of turbomachines that come into contact with fluid media, wherein the outer surface of parts of turbomachines that come into contact with fluid media are contacted by a coating comprising an inorganic-organic hybrid polymer. Furthermore, there is described a turbomachine, wherein the surfaces that come into contact with fluid media have an outer coating which comprises an inorganic-organic hybrid polymer. Such a turbomachine can be used for generating electric power.

### CROSS REFERENCE TO RELATED APPLICATIONS

This application is the US National Stage of International Application No. PCT/EP2006/065106, filed Aug. 7, 2006 and claims the benefit thereof. The International Application claims the benefits of German application No. 10 2005 038 119.7 DE filed Aug. 11, 2005, both of the applications are incorporated by reference herein in their entirety.

### FIELD OF INVENTION

The present invention relates to a coating method. In particular it relates to a method for coating the surfaces of turbomachines that come into contact with fluid media.

### BACKGROUND OF INVENTION

Dirt and deposits form in or on many turbomachines, including for example components of power plants, during their operating life and have an adverse effect on their operation. Also a high degree of corrosion results from cleaning such components, for example with water. Oil, dust or carbon black occurring in the environment of the components can be the cause of such problems. Examples of such components of power plants are gas turbine compressors and air-cooled generators, which become fouled as a result of impurities in the air, which are taken in by the compressor or generator cooling system. In the case of turbines the compressor stator, compressor rotor and in particular the compressor blades generally have to be cleaned at regular intervals to ensure correct operation of the turbine. The compressor blades are cleaned during operation of the turbine by spraying finely dispersed water into the compressor intake (online washing). Depending on the dust and/or oil pollution of the intake air, the cleaning process has to be repeated a number of times a week. However the water here is also a possible source of corrosion, in particular of the compressor rotor. An increase in the maintenance interval, operating life and availability of the components would be advantageous in this context. In addition to online washing, compressor blades also have to be cleaned manually in a subsequent operation during inspection of the plant. The cleaning process and the associated stoppage time of the plant are time-consuming and therefore expensive.

Until now it has been known that such compressor blades can be coated using a base layer containing aluminum and a chromate/phosphate cover layer to protect against corrosion. This type of coating is however disadvantageous, since it becomes dirty easily and has to be cleaned often, as described above. Also toxic Cr(VI) compounds have to be used during the chromating process.

### SUMMARY OF INVENTION

There is therefore a need for improved surface coatings for surfaces of turbomachines that come into contact with fluid media.

An object of the present invention is to overcome at least one of the described disadvantages of the prior art. In particular the object of the present invention is to provide a method for coating the surfaces of turbomachines that come into contact with fluid media in such a manner that the surfaces obtained are protected against corrosion, easy to clean and contain no toxic chromium compounds.

The object is achieved according to the invention by a method for coating the surfaces of turbomachines that come into contact with fluid media, with which the outer surface of parts of turbomachines that come into contact with fluid media are contacted with a coating comprising an inorganic-organic hybrid polymer, the coating being produced by causing monomers according to formula (I) below to react and then hardening them to form the coating:

(X)ₙ(Y)ₘM(OR)_{b-a} (I)

where:
M is Al, Si, Ti and/or Zr;
R is H or a branched or unbranched alkyl group with 1 to 9 C atoms;
X and Y are an organic group, independently of each other, comprising a non-reactive aryl, alkyl, fluoroalkyl, fluoroaryl, perfluoroalkyl and/or perfluoroaryl group or a reactive epoxy, acrylate, vinyl, allyl, isocyanate, amine and/or hydroxyl group;
n is 0, 1, 2, 3 or 4;
m is 0, 1, 2, 3 or 4;
(n+m)=a;
a is 1, 2, 3 or 4;
b is 3 or 4.

Within the meaning of the present invention the fluid media, which come into contact with the surfaces of the turbomachines, are selected from the group comprising gases, liquids and/or aerosols, preferably air and/or water. The media can be present at ambient temperature, below ambient temperature or above ambient temperature. For example air can be present at ambient temperature and an aerosol, such as a fuel/air mixture, can be present at a higher temperature.

Turbomachines within the meaning of the invention are fluid energy machines that operate continuously, in other words which establish a static pressure difference between the intake and outlet. They can be selected from the group comprising propellers, repellers, centrifugal pumps, fans, water turbines, compressors, steam turbines and/or gas turbines. In the context of the present invention propellers and repellers refer to turbomachines without housings, which absorb mechanical work and transfer this in the form of flow energy to the medium around them (propellers) or conversely take energy from the driving fluid and make this available in the form of mechanical rotation and torque (repellers). In the context of the present invention centrifugal pumps refer to pumps, in which a fluid medium is moved by mechanical work, with the mechanical work being transferred by the centrifugal force and deflection of the medium in impellers. Fans in contrast are devices used to set the ambient air in motion, without serving to drive an object in the process. Water turbines are turbines which make it possible to harness water power. In this process potential and/or kinetic energy is/are converted to mechanical work or directly to electric power by means of a generator on the turbine axis. Compressors in the context of the present invention refer to fluid energy machines used to compress gases. Steam turbines and gas turbines are models of turbine having a rotating shaft, which is fitted with turbine blades. Steam or hot gases, such as combustion gases, flow round the turbine blades.

Inorganic-organic hybrid polymers are materials having an inorganic network with organic components and optionally an additional organic network. Inorganic-organic hybrid polymers are derived from organically modified metal alkoxides. These metal alkoxides are referred to as monomers in the context of this invention.

The inorganic network is formed in a two-stage Sol-Gel process. First the metal alkoxides are partially or fully hydrolyzed, separating the corresponding alcohols. In a second step the metal hydroxides condense as the water separates to form the oxygen-bridged inorganic network.

Examples of branches or unbranched alkyl groups with 1 to 9 C atoms are selected from the group comprising methyl, ethyl, propyl, iso-propyl, n-butyl, iso-butyl and/or sec-butyl. Alkyl groups such as methyl or ethyl, which produce alcohols with a low boiling point after hydrolysis of the metal alkoxides, are preferred.

The organic groups X and Y, as described in the introduction, influence the characteristics of the coating to a significant degree. Hydrophobic organic groups can for example reduce the surface energy of the coating. Fluorinated groups are particularly effective in respect of reducing surface energy. This makes the coating hydrophobic and/or oleophobic, in other words it repels water or oil. As a result of the low surface energy the surface coating exhibits so-called easy-to-clean characteristics: water and organic liquids readily form droplets, facilitating the low adhesion forces and accelerating the mechanical removal of dust or dirt particles from the surface. Such hydrophobia or oleophobia can be expressed by the contact angle of the relevant liquid. The contact angle is the angle formed by the liquid droplet on the surface of a solid material in relation to said surface. The bigger the contact angle, the smaller the interaction of the liquid with the surface.

For example the contact angles of the surfaces coated according to the invention in respect of water can be in a range from ≧80° to ≦130°, preferably ≧90° to ≦130°, even more preferably ≧98° to ≦130°. Also for example the contact angles of the surfaces coated according to the invention in respect of CH₂I₂ can be in a range from ≧45° to ≦90°, preferably ≧50° to ≦90°, even more preferably ≧60° to ≦90°. For comparison, it should be pointed out that in the case of an untreated stainless steel surface the contact angle in respect of water is approx. 63° and in respect of CH₂I₂ approx. 38°.

Reactive and non-reactive organic groups X and Y can be used according to the invention. Non-reactive aryl, alkyl, fluoroalkyl, fluoroaryl, perfluoroalkyl and/or perfluoroaryl groups are selected from the group comprising phenyl, naphthyl, methyl, ethyl, propyl, iso-propyl, n-butyl, iso-butyl and/or sec-butyl, difluoromethyl, trifluoromethyl, pentafluoroethyl, C₆F₁₃, tridecafluoro-1,1,2,2-tetrahydrooctyl, fluorophenyl and/or pentafluorophenyl.

Reactive organic groups can be epoxy, acrylate, vinyl, allyl, isocyanate, amine and/or hydroxyl groups. These groups can also have hydrophobic characteristics according to the organic residue supporting them. They can also be able to react with other reactive groups and contribute to cross-linking of the hybrid polymer. Such an organic network results for example in better elasticity of the hybrid polymer.

The coating can be hardened thermally or photochemically. Hardening serves on the one hand to complete the condensation of the metal hydroxides to form an inorganic network. It can also serve to link the above-mentioned reactive organic groups to one another.

In a preferred embodiment of the present invention the coating also has inorganic microparticles and/or nanoparticles selected from the group comprising magnesium, zinc, iron, nickel, palladium, platinum, cobalt, rhodium, iridium, titanium dioxide, zirconium dioxide, ceroxide, vanadium pentoxide, aluminum oxide, silicon carbide and/or silicon dioxide. Microparticles within the meaning of the present invention are particles having measurements of ≦100 μm in one dimension at least; nanoparticles within the meaning of the present invention are particles having measurements of ≦100 nm in one dimension at least.

Typical functions provided by such particles are additional hydrophobia, scratch resistance, catalytic action (thermal or by UV light) and/or corrosion inhibition. It is particularly advantageous, if, at the operating temperatures of the coated component, the particles act as oxidation catalysts, to destroy adhering dirt. For better dispersibility or to adjust further characteristics, the particles can also be surface coated with substances selected from the group comprising silicon dioxide, silicon oils, silanes, aluminum hydroxide, stearic acid and/or aluminum oxide. The particles can also be added to the sol of the coating to be applied in the form of colloidal solutions. This allows good distribution of the particles in a simple manner.

In a further preferred embodiment the inventive method comprises the following steps:

a) Hydrolysis of the monomers according to formula (I)
b) a Application of the resulting reaction mixture to a surface by spraying, dipping, rolling and/or wiping;
c) Hardening of the applied reaction mixture by means of thermal hardening, hardening using UV light and/or hardening using visible light.

Hydrolysis of the monomers according to formula (I), in other words the metal alkoxides, starts the sol-gel process. Hydrolysis can be carried out in pure water or in the presence of further solvents, such as alcohols. One advantage of using a solvent mixture is that monomers with a lower level of solubility in water can also be processed. Hydrolysis can also be carried out in a multi-phase system of water and a solvent that is not miscible with water. This is expedient, if the monomer has a very low level of solubility in water. Hydrolysis can also be carried out in the presence of an acid, such as hydrochloric acid. This increases the reaction speed of the hydrolysis. The reaction temperature can be below ambient temperature, at ambient temperature or above ambient temperature. It is advantageous to carry out hydrolysis at ambient temperature, as no further energy is required for cooling or heating purposes and the risk of unwanted secondary reactions such as premature cross-linking is reduced due to the comparatively low reaction speed. This is important, as too high a level of cross-linking of the monomer causes the viscosity of the reaction mixture to increase, making it less easy to process, in other words to apply to the substrate. Similarly it is important that the reaction time of the hydrolysis is selected such that the most complete hydrolysis possible is achieved but where possible no premature cross-linking. This reaction time is preferably around 24 hours per mix.

The next step is to coat the substrate with the reaction mixture from the hydrolysis reaction. It is an advantage of the inventive coating method that the coating can be applied without further measures to protect again the action of oxygen or moisture. Standard methods can therefore be used. In the case of spraying for example, it is possible to use spray robots, which can coat complex shapes in a regular manner. It is a very simple procedure to dip the object to be coated. As with application by rolling or wiping, it is possible to coat already existing plants in situ with or advantageously without disassembly of the individual parts.

Application is followed by hardening, or the cross-linking of the reaction mixture from the hydrolysis reaction. Thermal hardening can advantageously be carried out at a temperature of ≧25° C. to ≦500° C., preferably ≧100° C. to ≦400° C., particularly preferably ≧150° C. to ≦300° C., most particularly preferably ≧170° C. to ≦250° C. Thermal hardening above 300° C. generally results in decomposition of the organic components and the formation of a high-temperature-resistant coating. This coating then displays a glass-type behavior.

Hardening of the coating by means of UV or visible light can be advantageous, when components are to be coated in a subsequent operation and disassembly of the plant containing said components does not appear expedient. The UV light can have a wavelength of ≧250 nm to ≦370 nm for example. The UV light spectrum can also have a maximum intensity at 360 nm. UV lamps, which emit light of such a wavelength, are widely available commercially and comparatively economical to use.

The sol used in the inventive method can comprise methyltriethoxysilane in a fraction from ≧50 percent by weight to ≦75 percent by weight. Such large weight fractions allow a high silicon fraction to be incorporated in the coating.

The sol used in the inventive method can also comprise 3-glycidyloxypropyltriethoxysilane in a fraction from ≧15 percent by weight to ≦30 percent by weight. Below this range subsequent cross-linking by way of the epoxy resin group no longer contributes significantly to an improvement in material characteristics. Above this range no significant increase in material characteristics can be anticipated compared with component costs.

The sol used in the inventive method can also comprise phenyltriethoxysilane in a fraction from ≧5 percent by weight to ≦15 percent by weight. Below this range the phenyl group no longer contributes significantly to the desired hydrophobia. Above this range a deterioration in mechanical stability and no significant improvement in the hydrophobia of the coating can be anticipated.

The sol used in the inventive method can also comprise tridecafluoro-1,1,2,2-tetrahydrooctyltriethoxysilane in a fraction from ≧0.5 percent by weight to ≦3 percent by weight. Below this range the fluoroalkyl group no longer contributes significantly to the desired hydrophobia. Above this range no significant improvement in hydrophobia and oleophobia can be anticipated compared with component costs.

The sol used in the inventive method can also comprise 1-methoxypropanol-2 in a fraction from ≧5 percent by weight to ≦15 percent by weight. This medium-volatility solvent that is miscible with water has the advantage of good biodegradability.

A further subject of the invention relates to a coating, which can be produced according to the inventive method.

The hardened coating can have a silicon content from ≧1 percent by weight to ≦50 percent by weight, preferably ≧5 percent by weight to ≦30 percent by weight, particularly preferably ≧10 percent by weight to ≦20 percent by weight, most particularly preferably from ≧13 percent by weight to ≦17 percent by weight.

The hardened coating can also have a contact angle in respect of water from ≧80° to ≦130°, preferably ≧90° to ≦130°, even more preferably ≧98° to ≦130°.

Similarly the hardened coating can have a contact angle in respect of CH₂I₂ from ≧45° to ≦90°, preferably ≧50° to ≦90°, even more preferably ≧60° to ≦90°.

The silicon content, expressed in percent by weight, is calculated as a fraction by weight of the silicon atoms contained in the coating in relation to the overall weight of the coating.

The silicon content in the said ranges allows the highest possible number of silicon atoms to enter into the highest possible number for them of cross-linking operations and the smallest possible number of free OH groups to remain left on the silicon atom. The more free OH groups remain left, the poorer the water-repelling characteristics of the coating.

As already mentioned above, the inventive coating advantageously influences the characteristics of the coated surface. The surface energy is reduced, with the result that dirt adheres less easily and can be removed with less effort. The inventive surface and the work piece overall are also protected against corrosion. Use in aggressive environments, e.g. salty water, is therefore also possible.

A further subject of the present invention relates to a turbomachine with an inventive outer surface coating. As mentioned above, such turbomachines are characterized for example by easier cleaning and a higher level of corrosion protection.

To adjust further advantageous characteristics such as hydrophobia, scratch resistance, catalytic action (thermal or by UV light) and/or corrosion inhibition, the inventive turbomachine can also comprise inorganic microparticles and/or nanoparticles selected from the group comprising magnesium, zinc, iron, nickel, palladium, platinum, cobalt, rhodium, iridium, titanium dioxide, zirconium dioxide, ceroxide, vanadium pentoxide, aluminum oxide, silicon carbide and/or silicon dioxide in its outer surface coating. In addition to the passive corrosive inhibition mentioned above, a further effect can occur in the form of active corrosion inhibition according to the reactive anode principle. This makes it possible to use the inventive surfaces and work pieces as a whole in corrosive media.

A further subject of the invention relates to the use of turbomachines for generating electric power with surfaces that come into contact with fluid media coated according to the invention. They can be used for example with compressors, for example in gas turbines. Compared with conventionally coated or uncoated components, such components can be cleaned at longer intervals, need less time for cleaning and can be cleaned more efficiently by means of online washing. The components also demonstrate a lower level of corrosion and therefore have a longer useful life and operating time. The efficiency and availability of the components can also be kept at a high level.

The subject of the invention is described below with reference to examples 1 and 2. The data in percent by weight, unless otherwise stated, relates to the total weight of the sol. The quantities of the components are selected in such a manner that the sum of the quantity data reaches maximum 100 percent by weight.

### EXAMPLE 1

A sol was made up of the following components:

| Component | Fraction in percent by weight |
|---|---|
| Methyltriethoxysilane | ≧50 to ≦75 |
| Phenyltriethoxysilane | ≧5 to ≦15 |
| 1-methoxypropanol-2 | ≧5 to ≦15 |
| Isopropanol | ≧5 to ≦50 |
| Water | ≧1 to ≦30 |
| Hydrochloric acid (37%) | ≧0 to ≦0.5 |

### EXAMPLE 2

A sol was made up of the following components:

| Component | Fraction in percent by weight |
|---|---|
| 3-glycidyloxypropyltriethoxysilane | ≧15 to ≦30 |
| Tridecafluoro-1,1,2,2- | ≧0.5 to ≦3 |
| tetrahydrooctyltriethoxysilane | |
| Methoxypropanol | ≧5 to ≦15 |
| Isopropanol | ≧5 to ≦50 |
| Water | ≧1 to ≦30 |
| Hydrochloric acid (37%) | ≧0 to ≦0.5 |

The sols were stirred for 24 hours at ambient temperature and applied to a stainless steel specimen body by dipping. After a ventilation period of 10 minutes at ambient temperature, the coatings were hardened for 10 minutes at 200° C.

1.-10. (canceled)

11. A method for coating a surface of a part of a turbomachine, comprising:
coating the surface of the part of the turbomachine, wherein the coated surface is supposed to come into contact with a fluid media, wherein the coating has an inorganic-organic hybrid polymer, and wherein the coating is produced by causing monomers to react according to formula
(X)ₙ(Y)ₘM(OR)_{b-a}
wherein:
M is selected from the group consisting of Al, Si, Ti, Zr and a combination thereof,
R is H or a branched or unbranched alkyl group with 1 to 9 C atoms,
X and Y are an organic group, independently of each other, wherein the organic group has a substance selected from the group consisting of
a non-reactive aryl group, a non-reactive alkyl group, a non-reactive fluoroalkyl group, a non-reactive fluoroaryl group, a non-reactive perfluoroalkyl group, a non-reactive perfluoroaryl group, and a combination thereof, or
a reactive epoxy group, a reactive acrylate group, a reactive vinyl group, a reactive allyl group, a reactive isocyanate group, a reactive amine group, a reactive hydroxyl group, and a combination thereof,
n is 0, 1, 2, 3 or 4,
m is 0, 1, 2, 3 or 4,
(n+m)=a,
a is 1, 2, 3 or 4,
b is 3 or 4; and
hardening a result of the reaction.

12. The method as claimed in claim 11, wherein the coating has inorganic microparticles selected from the group consisting of magnesium, zinc, iron, nickel, palladium, platinum, cobalt, rhodium, iridium, titanium dioxide, zirconium dioxide, ceroxide, vanadium pentoxide, aluminum oxide, silicon carbide, silicon dioxide, and a combination thereof.

13. The method as claimed in claim 11, wherein the coating has inorganic nanoparticles selected from the group consisting of magnesium, zinc, iron, nickel, palladium, platinum, cobalt, rhodium, iridium, titanium dioxide, zirconium dioxide, ceroxide, vanadium pentoxide, aluminum oxide, silicon carbide, silicon dioxide, and a combination thereof.

14. The method as claimed in claim 12, wherein the particles have a surface coating, wherein the surface coating has a substances selected from the group consisting of silicon dioxide, silicon oils, silanes, aluminum hydroxide, stearic acid, aluminum oxide and a combination thereof.

15. The method as claimed in claim 13, wherein the particles have a surface coating, wherein the surface coating has a substances selected from the group consisting of silicon dioxide, silicon oils, silanes, aluminum hydroxide, stearic acid, aluminum oxide and a combination thereof.

16. The method as claimed in claim 11, further comprising:
hydrolysing the monomers based upon the formula,
applicating a resulting reaction mixture to a surface, and
hardening of the applied reaction mixture.

17. The method as claimed in claim 16, wherein the hardening is based on a method selected from the group consisting of a thermal hardening, a UV light base hardening, a hardening using visible light, and a combination thereof.

18. The method as claimed in claim 16, wherein the application of the resulting reaction mixture to the surface is based on a method selected form the group consisting of spraying, dipping, rolling, wiping, and a combination thereof.

19. The method as claimed in claim 16, wherein the hardening is carried out at a temperature from ≧25° C. to ≦500° C.

20. The method as claimed in claim 16, wherein the hardening is carried out at a temperature from ≧100° C. to ≦400° C.

21. The method as claimed in claim 16, wherein the hardening is carried out at a temperature from ≧150° C. to ≦300° C.

22. The method as claimed in claim 16, wherein the hardening is carried out at a temperature from ≧170° C. to ≦250° C.

23. The method as claimed in claim 11, wherein the fluid media is selected from the group consisting of a gas, a liquid, an aerosol, air, water, and a combination thereof.

24. The method as claimed in claim 16, wherein the turbomachine is selected from the group consisting of a propeller, a repeller, a centrifugal pump, a fan, a water turbine, a compressor, a steam turbine and a gas turbine.

25. A coating of a surface of a turbomachine, comprising:
an inorganic-organic hybrid polymer, wherein the coating is hardened, and wherein the coating is based upon a reaction of monomers according to a formula
(X)ₙ(Y)ₘM(OR)_{b-a}
wherein:
M is selected from the group consisting of Al, Si, Ti, Zr and a combination thereof,
R is H or a branched or unbranched alkyl group with 1 to 9 C atoms,
X and Y are an organic group, independently of each other, wherein the organic group has a substance selected from the group consisting of
a non-reactive aryl group, a non-reactive alkyl group, a non-reactive fluoroalkyl group, a non-reactive fluoroaryl group, a non-reactive perfluoroalkyl group, a non-reactive perfluoroaryl group, and a combination thereof, or
a reactive epoxy group, a reactive acrylate group, a reactive vinyl group, a reactive allyl group, a reactive isocyanate group, a reactive amine group, a reactive hydroxyl group, and a combination thereof,
n is 0, 1, 2, 3 or 4,
m is 0, 1, 2, 3 or 4,
(n+m)=a,
a is 1, 2, 3 or 4,
b is 3 or 4, and
wherein the hardened coating has a silicon content from ≧1 percent by weight to ≦50 percent by weight.

26. The coating as claimed in claim 25, wherein the hardened coating has a silicon content from ≧5 percent by weight to ≦30 percent by weight.

27. The coating as claimed in claim 25, wherein the hardened coating has a silicon content from ≧20 percent by weight to ≦20 percent by weight.

28. The coating as claimed in claim 25, wherein the hardened coating has a silicon content from preferably from ≧13 percent by weight to ≦17 percent by weight.

29. A turbomachine, comprising:
a part having an outer surface coating, wherein the coating has
an inorganic-organic hybrid polymer, wherein the coating is hardened, and wherein the coating is based upon a reaction of monomers according to a formula
(X)ₙ(Y)ₘM(OR)_{b-a}
wherein:
M is selected from the group consisting of Al, Si, Ti, Zr and a combination thereof,
R is H or a branched or unbranched alkyl group with 1 to 9 C atoms,
X and Y are an organic group, independently of each other, wherein the organic group has a substance selected from the group consisting of
a non-reactive aryl group, a non-reactive alkyl group, a non-reactive fluoroalkyl group, a non-reactive fluoroaryl group, a non-reactive perfluoroalkyl group, a non-reactive perfluoroaryl group, and a combination thereof, or
a reactive epoxy group, a reactive acrylate group, a reactive vinyl group, a reactive allyl group, a reactive isocyanate group, a reactive amine group, a reactive hydroxyl group, and a combination thereof,
n is 0, 1, 2, 3 or 4,
m is 0, 1, 2, 3 or 4,
(n+m)=a,
a is 1, 2, 3 or 4,
b is 3 or 4.
wherein the hardened coating has a silicon content from ≧1 percent by weight to ≦50 percent by weight,
wherein a contact angle in respect of water is selected from the group consisting of ≧80° to ≦130°, ≧90° to ≦130°, and ≧98° to ≦130°, and
wherein a contact angle in respect of CH₂I₂ is selected from the group consisting of ≧45° to ≦90°, ≧50° to ≦90°, and ≧60° to ≦90°.

30. The turbomachine as claimed in claim 29, wherein the outer surface coating has inorganic microparticles and/or nanoparticles selected from the group consisting of magnesium, zinc, iron, nickel, palladium, platinum, cobalt, rhodium, iridium, titanium dioxide, zirconium dioxide, ceroxide, vanadium pentoxide, aluminum oxide, silicon carbide, silicon dioxide, and a combination thereof.
